(19) United States
(12) Patent Application Publication
(10) Pub. No.: US 2026/0266374 A1
(43) Pub. Date: Sep. 10, 2026

(54) NON-EXTRUSION DEVICE USING SHAPE MEMORY ALLOY FOR EXTENDING OPERATIONAL TEMPERATURE RANGE OF SEALS

(71) Applicant: FMC Technologies, Inc., Houston, TX (US)

(72) Inventors: David Zollo, Spring, TX (US); Harold Brian Skeels, Houston, TX (US)

(21) Appl. No.: 19/075,324

(22) Filed: Mar. 10, 2025

(51) Int. Cl. F16J 15/02; F03G 7/06

(52) U.S. Cl. CPC F16J 15/028; F03G 7/06145; F03G 7/0616; F16J 15/022; F05B 2280/10304

(57) ABSTRACT

A sealing system may include a first component, a second component, and a seal. The seal may establish sealing between the first component and the second component at low and high-temperature conditions. The seal may include one or more non-extrusion devices embedded within a seal body of the seal. The one or more non-extrusion devices may each comprise a non-extrusion ring and a shape memory alloy (SMA) ring embedded within the non-extrusion ring, wherein the one or more non-extrusion devices may be in a non-contracted state at a first temperature and a contracted state at a second temperature, wherein the second temperature may be higher than the first temperature, wherein the one or more non-extrusion devices may transition from the non-contracted state to the contracted state upon reaching a first transition temperature.

### RELATED APPLICATIONS

This patent application shares certain subject matter in common with earlier-filed U.S. patent application Ser. No. 16/306,729, now U.S. Pat. No. 10,612,658. The above-referenced patent is hereby incorporated by reference in its entirety into the present application.

### BACKGROUND

### 1. FIELD

Embodiments of the present disclosure relate to a non-extrusion device embedded with a shape memory alloy component for use in high-pressure sealing applications.

### 2. RELATED ART

Seals are typically designed to function within narrow differential pressure and temperature ranges. Exceeding these temperature thresholds while under differential pressure often results in the mechanical degradation of the seal or the deterioration of its material properties, ultimately leading to collapse or failure. Customizations in seal designs and materials are frequently tailored to address either extreme heat conditions or extreme cold conditions, but such solutions do not perform effectively across a full spectrum of temperature extremes. Consequently, a design optimized for high temperatures may lack sufficient sealing capabilities at low temperatures and vice versa, leaving a deficiency in seal performance under fluctuating or extreme environmental conditions.

Moreover, existing strategies to mitigate seal damage, such as incorporating non-extrusion devices or additional materials used to enhance the performance or durability of the seal, also face limitations. Seal extrusion occurs when temperature-induced expansion or contraction of adjacent materials increases the dimensions of extrusion gaps, creating pathways through which the seal material may be forced under pressure and damaged. Non-extrusion devices, often more rigid than the seals themselves, act as physical barriers to prevent seal extrusion from occurring. However, the non-extrusion devices can fail under pressure as the extrusion gaps widen due to thermal expansion, leading to structural damage that propagates to the seal. For example, at higher temperatures, where the pressure on the seal is increased, the seal material may be forced into the widened extrusion gaps and damaged due to the increased pressure. Accordingly, there is a need to develop a solution that maintains seal integrity across a wide range of temperatures and pressures.

### SUMMARY

Embodiments of the present disclosure solve the above-mentioned problems by providing a non-extrusion device embedded with a shape memory alloy ring.

In some embodiments, the techniques described herein relate to a seal, including: a seal body; and a non-extrusion device embedded within the seal body at a location proximal to an extrusion gap edge of the seal body, the non-extrusion device including: a non-extrusion ring; and a shape memory alloy (“SMA”) ring embedded within the non-extrusion ring; wherein the non-extrusion device is in a non-contracted state at a first temperature and a contracted state at a second temperature, wherein the second temperature is higher than the first temperature; and wherein the non-extrusion device transitions from the non-contracted state to the contracted state upon reaching a first transition temperature.

In some embodiments, the techniques described herein relate to a seal, wherein the SMA ring is a helical spring including one or more strands of SMA wire.

In some embodiments, the techniques described herein relate to a seal, wherein the SMA ring begins changing from a martensitic molecular structure to an austenitic molecular structure upon the SMA ring reaching the first transition temperature, wherein the first transition temperature is an austenite start transformation temperature.

In some embodiments, the techniques described herein relate to a seal, wherein after the SMA ring reaches the first transition temperature, the SMA ring finishes changing to the austenitic molecular structure upon the SMA ring reaching a first finish transition temperature, wherein the first finish transition temperature is an austenite finish transformation temperature, wherein the SMA ring begins changing from the austenitic molecular structure to the martensitic molecular structure upon the SMA ring reaching a second transition temperature, wherein the second transition temperature is a martensite start transformation temperature.

In some embodiments, the techniques described herein relate to a seal, wherein the SMA ring finishes changing to the martensitic molecular structure upon the SMA ring reaching a second finish transition temperature, wherein the second finish transition temperature is a martensite finish temperature.

In some embodiments, the techniques described herein relate to a seal, wherein the first transition temperature is higher than the second transition temperature.

In some embodiments, the techniques described herein relate to a seal, wherein the SMA ring begins to circumferentially contract upon the SMA ring reaching the first transition temperature.

In some embodiments, the techniques described herein relate to a seal, wherein the non-extrusion ring is a flat spring.

In some embodiments, the techniques described herein relate to a sealing system, including: a first component including a seal recess defined in the first component; a second component including a sealing surface; and a seal positioned in the seal recess, the seal including: a seal body; and a non-extrusion device embedded within the seal body, the non-extrusion device including: a non-extrusion ring; and a shape memory alloy (SMA) ring embedded within the non-extrusion ring, wherein the non-extrusion device is in a non-contracted state at a first temperature and a contracted state at a second temperature, wherein the non-extrusion device transitions from the non-contracted state to the contracted state upon reaching a first transition temperature, and wherein, upon reaching the first transition temperature, the SMA ring circumferentially contracts such that the non-extrusion device contracts in a direction toward the sealing surface.

In some embodiments, the techniques described herein relate to a sealing system, further including: one or more extrusion gaps located between the first component and the second component, wherein the non-extrusion device contracts in the direction toward the sealing surface such that the non-extrusion device at least partially blocks the one or more extrusion gaps.

In some embodiments, the techniques described herein relate to a sealing system, wherein the seal further includes: an extrusion gap edge, wherein the non-extrusion device is embedded within the seal body at a location proximal to the extrusion gap edge.

In some embodiments, the techniques described herein relate to a sealing system, wherein the non-extrusion device transitions from the contracted state to the non-contracted state upon reaching a second transition temperature such that the non-extrusion device ceases to contract in the direction toward the sealing surface.

In some embodiments, the techniques described herein relate to a sealing system, wherein the second transition temperature is lower than the first transition temperature.

In some embodiments, the techniques described herein relate to a sealing system, wherein the second transition temperature is a martensite start temperature of the SMA ring.

In some embodiments, the techniques described herein relate to a sealing system, wherein the seal has a first pliancy in the non-contracted state and a second pliancy in the contracted state, wherein the first pliancy is greater than the second pliancy.

In some embodiments, the techniques described herein relate to a sealing system, wherein the first transition temperature is an austenite start temperature of the SMA ring.

In some embodiments, the techniques described herein relate to a sealing system, wherein the first transition temperature is determined by a ratio of nickel to titanium that the SMA ring includes.

In some embodiments, the techniques described herein relate to a method of manufacturing a sealing system, the method including: forming a seal, wherein the seal is formed by: embedding a shape memory alloy (SMA) ring within a non-extrusion ring to form a non-extrusion device; and embedding the non-extrusion device within a seal body; disposing the seal onto a first component such that the seal is positioned in a seal recess defined in the first component; and installing a second component, such that a sealing surface of the second component contacts a surface of the seal, wherein one or more extrusion gaps are formed between the sealing surface and the surface of the seal, wherein the non-extrusion device is embedded within the seal body such that the non-extrusion device is proximal to an extrusion gap edge of the seal body after the second component is installed.

In some embodiments, the techniques described herein relate to a method, wherein the method further includes: heating the seal to a first transition temperature, wherein upon reaching the first transition temperature, the SMA ring begins to circumferentially contract from a non-contracted state to a contracted state such that the non-extrusion device contracts in a direction toward the sealing surface, wherein the non-extrusion device at least partially blocks the one or more extrusion gaps.

In some embodiments, the techniques described herein relate to a method, wherein the method further includes: cooling the seal to a second transition temperature, wherein upon reaching the second transition temperature, the SMA ring begins to circumferentially expand from the contracted state to the non-contracted state, such that the non-extrusion device ceases to contract in the direction toward the sealing surface.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1A illustrates a cross-sectional view of an exemplary non-extrusion device for use in sealing applications;

FIG. 1B illustrates a cross-sectional view of an exemplary non-extrusion device operating at a high temperature;

FIG. 1C illustrates a cross-sectional view of an exemplary non-extrusion device operating at a low temperature;

FIG. 2A illustrates a cross-sectional view of an exemplary sealing system using a seal embedded with one or more non-extrusion devices to establish a seal between two components;

FIG. 2B illustrates a cross-sectional view of an exemplary sealing system using a seal embedded with one or more non-extrusion devices, operating at a high temperature, to establish a seal between two components;

FIG. 2C illustrates a cross-sectional view of an exemplary sealing system using a seal embedded with one or more non-extrusion devices, operating at a high temperature, to establish a seal between two components;

FIG. 2D illustrates a cross-sectional view of an exemplary sealing system using a seal embedded with one or more non-extrusion devices, operating at a low temperature, to establish a seal between two components;

FIG. 3 illustrates a chart describing operational characteristics of an example embodiment of the non-extrusion device; and

FIG. 4 illustrates an exemplary method of manufacturing a sealing system using one or more non-extrusion devices.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Embodiments of the present disclosure are directed to a sealing system comprising a first component including a seal recess, a second component including a sealing surface, a seal, and a non-extrusion device. One or more extrusion gaps are located between the first component and the second component. The non-extrusion device may be embedded within the seal (e.g., polymer seal). The non-extrusion device may comprise a non-extrusion ring and a shape memory alloy (SMA) ring embedded within the non-extrusion ring. In some embodiments, the non-extrusion device is configured to transition from a non-contracted state to a contracted state upon reaching a first transition temperature. For example, upon the seal being heated to the first transition temperature, the non-extrusion device may transition to a contracted state, where the SMA ring circumferentially contracts. For instance, the SMA ring may contract radially so that a diameter of the SMA ring decreases in size equal to C/(2π), where C is the circumference of the SMA ring.

Extrusion gaps in sealing systems pose a risk to the integrity of seals during high-pressure situations. For example, when exposed to high pressures at high temperature conditions, the high temperature causes extrusion gaps to widen due to the thermal expansion of adjacent materials, where the material of the seal is then forced toward these widened extrusion gaps due to the increased pressure on the seal, leading to a phenomenon known as extrusion. Over time, this movement of the seal causes the seal material to deform and stretch into the extrusion gaps, resulting in physical damage to the seal, such as tearing, nibbling, or material loss. This damage compromises the seal's ability to contain pressure and accelerates wear and eventual failure, especially when the extrusion gaps widen due to thermal expansion or mechanical distortion of surrounding components (e.g., the first component and the second component). In response to the contraction of the SMA ring under, for example, high pressure and high temperature conditions, the non-extrusion device contracts in a direction toward the sealing surface such that the non-extrusion device at least partially blocks (or fills) one or more extrusion gaps.

Further, once in the contracted state, the non-extrusion device may transition back to a non-contracted state upon reaching a second transition temperature. For example, when the seal is cooled to a second transition temperature, the non-extrusion device may transition to the non-contracted state. The second transition temperature may be different than the first transition temperature. The non-contracted state is the state the non-extrusion device was in before the non-extrusion device transitioned to the contracted state. In the non-contracted state, the non-extrusion device ceases to contract in the direction toward the sealing surface. Further, in the non-contracted state, the SMA ring prevents shrinkage or further damage to the seal body by expanding and returning to a non-contracted state to maintain contact stress between an outside diameter of the seal body and the inside diameter of the seal recess. For example, the SMA ring may be a spring that controls the shrinkage of the seal body that occurs naturally as the seal is cooled. For instance, as the seal is cooled, the seal body will tend to shrink to the center of mass of the seal body. However, the SMA ring has a two-way shape memory effect which causes the SMA ring to expand back to its non-contracted shape upon being cooled and prevents the seal body from shrinking while maintaining sufficient contact stress between the seal body and the seal recess. In contrast to the seal while in the contracted state, the seal may be more easily strained to a different shape while in the non-contracted state.

The non-extrusion device disclosed herein allows the seal to operate at a broader temperature range, in contrast to prior art seals, by adapting the seal to both hot and cold temperature conditions (as discussed further below). For example, at lower temperatures, the non-extrusion device may be in the non-contracted state so that the seal maintains pliability for sealing. Then, at higher temperatures, where the pressure exerted on the seal is increased, the non-extrusion device may be in the contracted state so that the non-extrusion device contracts in a direction toward the sealing surface such that the non-extrusion device at least partially blocks one or more extrusion gaps to prevent extrusion from occurring. As further discussed below, the two-way shape memory effect of the SMA ring to change its lattice molecular structure from martensitic to austenitic, and vice versa, at various temperatures, allows the non-extrusion device to swap between the non-contracted state and the contracted state for improved sealing capabilities.

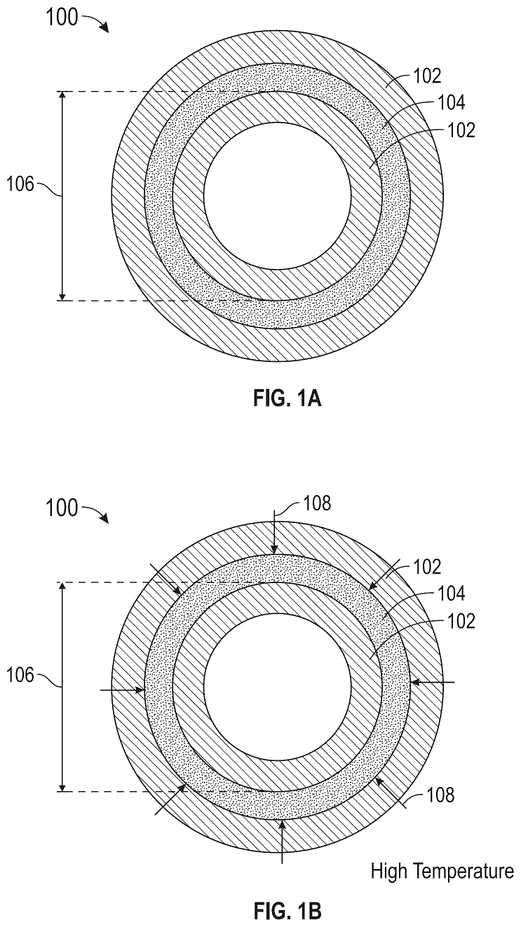

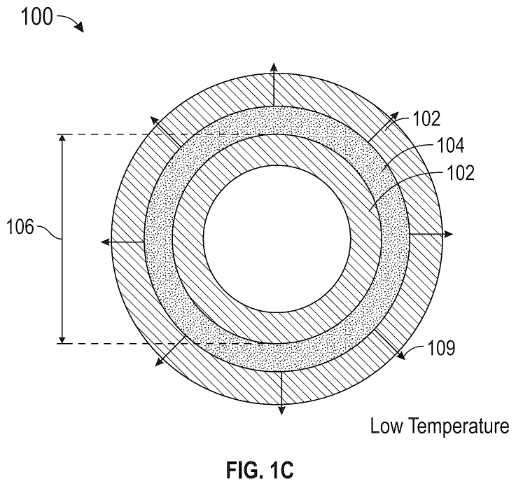

FIG. 1A illustrates a cross-sectional view of a non-extrusion device 100 for use in sealing applications. Non-extrusion device 100 may comprise a non-extrusion ring 102 and an SMA ring 104. In some embodiments, SMA ring 104 is embedded within non-extrusion ring 102. For example, SMA ring 104 may be embedded within non-extrusion ring 102 so SMA ring 104 is fully enclosed by non-extrusion ring 102. In other embodiments, SMA ring 104 may only be partially embedded within non-extrusion ring 102 so only a portion of SMA ring 104 is enclosed by non-extrusion ring 102. In some embodiments, non-extrusion device 100 only comprises SMA ring 104.

Non-extrusion device 100 further comprises an inner diameter 106. Inner diameter 106 may be the inner diameter of SMA ring 104. In some embodiments, non-extrusion device 100 may be in a non-contracted state or a contracted state. In some embodiments, non-extrusion device 100 may be in a non-contracted state when SMA ring 104 is at or below a first transition temperature (e.g., low temperature conditions). In some embodiments, non-extrusion device 100 may be in a contracted state when SMA ring 104 is at or above a first transition temperature (e.g., high temperature conditions). In a non-contracted state, inner diameter 106 of SMA ring 104 is equal to a first diameter. In a contracted state, inner diameter 106 of SMA ring 104 is equal to a second diameter, where the second diameter may be less than the first diameter.

In some embodiments, non-extrusion ring 102 comprises a polymer material. For example, non-extrusion ring 102 may comprise PEEK (polyether ether ketone), PTFE (polytetrafluoroethylene), and/or nylon material. Non-extrusion ring 102 may be any shape or size now known or later developed that could be used with respect to embodiments described herein. In some embodiments, non-extrusion ring 102 is a hollow or partially hollow cylindrical ring. In some embodiments, non-extrusion ring 102 is a spring. For example, non-extrusion ring 102 may be a flat spring or a coiled spring.

In some embodiments, SMA ring 104 comprises SMA material. SMA materials are materials that can return to a pre-defined shape (e.g., pre-wrought) when exposed or unexposed to specific conditions, such as heat, stress, or strain. SMA ring 104 may comprise nickel-titanium alloys (nitinol), copper-based alloys, iron-based alloys, silver-cadmium alloys, zirconium-titanium-based alloys, or any combination thereof. SMA ring 104 may comprise any ratio of metals or metal alloys. For example, SMA ring 104 may comprise 49.9% nickel and 50.1% titanium. In another example, SMA ring 104 may comprise nickel, titanium, and copper. In an even further example, SMA ring 104 may comprise 55-56% nickel and 44-45% titanium.

SMA ring 104 may be any shape or size now known or later developed that could be used in embodiments described herein. In some embodiments, SMA ring 104 is a spring such as a flat spring or a helical spring. In some embodiments, SMA ring 104 may comprise strands (e.g., wire) of different types of metal alloys coiled in the shape of a helix. For instance, SMA ring 104 may be a helical spring comprising nitinol strands coiled in the shape of a helix. In other embodiments, SMA ring 104 is a non-helical spring (e.g., any type of wire ring). In some embodiments, SMA ring 104 is a solid, hollow, or partially hollow cylindrical ring comprising strands of SMAs.

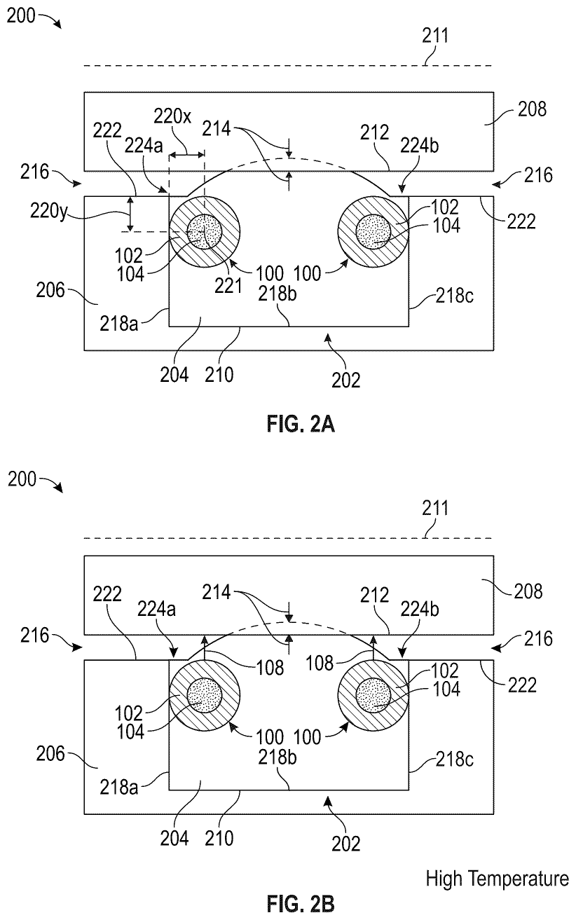

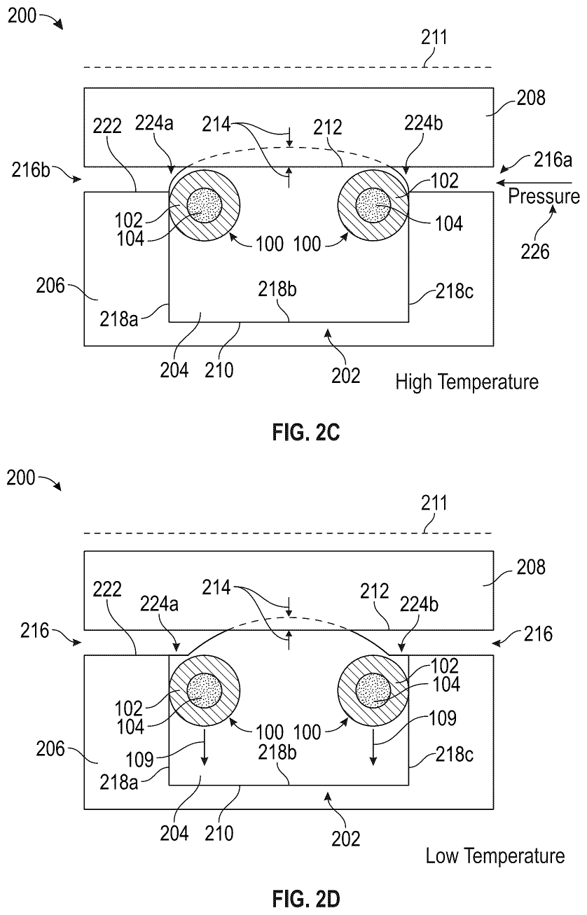

FIG. 1B illustrates a cross-sectional view of non-extrusion device 100 operating at or above a first transition temperature. Non-extrusion device 100 may transition from a non-contracted state (e.g., initial state) to a contracted state when the first transition temperature is reached. For example, upon reaching the first transition temperature, the SMA ring 104 contracts, which causes the non-extrusion device 100 to transition to a contracted state. For example, when non-extrusion device 100 operates at or above the first transition temperature, the lattice molecular structure of SMA ring 104 changes from martensitic to austenitic, and SMA ring 104 transitions to the contracted state. For instance, upon reaching a first transition temperature, SMA ring 104 may begin contracting (e.g., constricting) circumferentially. In some embodiments, SMA ring 104 may begin circumferentially contracting so that a diameter of SMA ring 104 decreases in size equal to C/(2π), where C is the circumference of SMA ring 104. This contraction in size of SMA ring 104 may reduce the inner diameter 106 of SMA ring 104. By reducing the inner diameter 106, non-extrusion device 100 experiences an inward contraction 108 directed toward the center of non-extrusion device 100. Inward contraction 108 will be further described below in FIGS. 2B-2C.

In some embodiments, the contraction of SMA ring 104 may be a partial contraction such as a percentage or degree of contraction. For example, SMA ring 104 may contract at least 1 percent, at least 50 percent, at least 75 percent, or at least 90 percent of the inner diameter 106 of SMA ring 104. Although SMA ring 104 is described herein relative to a ring, it should be appreciated that the structure of SMA ring 104 may include other shapes within the definition of ring, such as elliptical or oval shapes. In such configurations, the contraction may similarly be defined in terms of a percentage or degree of contraction relative to a major and/or minor axis, or as at least a partial contraction.

As discussed above, the SMA ring 104 may comprise one or more SMA materials. The first transition temperature may depend on the SMA materials' composition. For example, non-extrusion device 100 may be selectively transitioned from a non-contracted state to a contracted state based on the components of the SMA materials. For instance, the first transition temperature may be selectively raised or lowered by raising or lowering the ratio of nickel to titanium within the SMA materials.

FIG. 1C illustrates a cross-sectional view of non-extrusion device 100 operating at or below a second transition temperature. Once in the contracted state, non-extrusion device 100 may transition back to a non-contracted state upon reaching the second transition temperature. For example, upon reaching or falling below the second transition temperature, non-extrusion device 100 transitions to the non-contracted state where the lattice molecular structure of SMA ring 104 changes from austenitic to martensitic.

Additionally, the second transition temperature may depend on the SMA material. For example, the second transition temperature may be selectively raised or lowered by raising or lowering the ratio of nickel to titanium within the SMA materials.

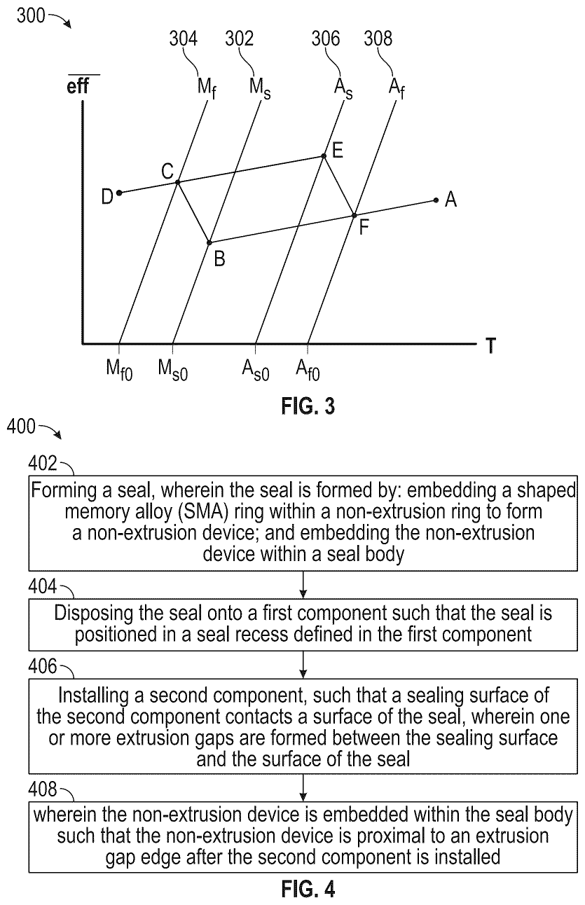

It is noted herein that the second transition temperature may be different than the first transition temperature. Further, the first transition temperature and the second transition temperature discussed herein may be a particular temperature point or a temperature range. For example, as further discussed in FIG. 3 below, the first transition temperature may be an austenite start temperature, or a temperature range from the austenite start temperature to an austenite finish temperature. In another example, the second transition temperature may be a martensite start temperature, or a temperature range from the martensite start temperature to a martensite finish temperature. For instance, upon SMA ring 104 being heated to the austenite start temperature, or a temperature range from the austenite start temperature to the austenite finish temperature, non-extrusion device 100 may be in the contracted state. Then, upon SMA ring 104 being cooled to the martensite start temperature, or a temperature range from the martensite start temperature to the martensite finish temperature, non-extrusion device 100 may be in the non-contracted state. In some embodiments, non-extrusion device 100 instantaneously transitions to a new state (e.g., non-contracted or contracted) upon reaching the first transition temperature or the second transition temperature. In other embodiments, non-extrusion device 100 gradually (e.g., over a 5-10 second period) transitions to a new state over a temperature range. For example, non-extrusion device 100 may begin transitioning from the contracted state to the non-contracted state upon reaching the martensite start temperature but may not finish transitioning to the non-contracted state until non-extrusion device 100 reaches the martensite finish temperature.

The shape of non-extrusion device 100 in the non-contracted state may be the same or substantially similar to the shape the non-extrusion device 100 was in before the non-extrusion device 100 transitioned to the contracted state. In the non-contracted state, inward contraction 108 may no longer (e.g., cease to) contract non-extrusion device 100. For example, as SMA ring 104 expands in an outward direction 109 back to the non-contracted state, inner diameter 106 may return to the same or a substantially similar length as inner diameter 106 of SMA ring 104 was before transitioning to the contracted state. Outward direction 109 may be opposite the direction of inward contraction 108, or substantially opposite the direction of inward contraction 108. In some embodiments, SMA ring 104 is more pliable in the non-contracted state than the contracted state, making non-extrusion device 100 more easily strained or adjusted to a different shape at lower temperatures.

FIG. 2A illustrates a cross-sectional view of a sealing system 200 using a seal 202 embedded with one or more non-extrusion devices 100 to establish a seal between two components.

Sealing system 200 includes a seal 202, where the seal 202 may comprise a seal body 204 and one or more non-extrusion devices 100. Seal body 204 may surround non-extrusion devices 100. In some embodiments, one or more non-extrusion devices 100 may be embedded (e.g., disposed) within the seal body 204, where each non-extrusion device 100 comprises non-extrusion ring 102 and SMA ring 104. Further, sealing system 200 may include a first component 206 and a second component 208. In some embodiments, the first component 206 comprises a seal recess 210, wherein the seal recess 210 is defined in first component 206. In some embodiments, second component 208 comprises a sealing surface 212. In some embodiments, the first component 206 comprises an outer portion of the sealing system 200, and the second component 208 comprises an inner portion of the sealing system 200. Each of the first component 206 and the second component 208 fully extend or partially extend around a central axis 211 of sealing system 200

In some embodiments, sealing system 200 includes seal 202 having a sealing interference 214, where an operative sealing interference 214 is one where seal 202 substantially prevents liquid or gas from escaping the sealed cavity (e.g., pipe or tubing) under normal operating conditions for the use environment. In use environments where the operating temperature range can vary (e.g., −75° F. to 650° F.), seal 202 is commonly optimized for an operative sealing interference 214 at either a high temperature condition (for the particular use environment) or for a low temperature condition (again, for the particular use environment). The drawback in optimizing seal 202 for a particular operating temperature is that the interference for seal 202 may not be sufficient when at least some expected operating temperatures are reached. An insufficient seal may include an insufficient sealing interference such that a liquid or gas escapes through extrusion gaps 216 of sealing system 200 resulting in a decrease in the sealing efficiency. In some embodiments, an insufficient seal 202 includes any type of deficiency effecting the operability or wear of seal 202 such as seal material being deformed and stretched into the extrusion gaps 216, or any physical damage to the seal 202, such as unwanted tearing, nibbling, or material loss during operating conditions.

For example, if sealing system 200 is optimized for operative sealing interference 214 at high temperature conditions, it may result in insufficient interference at low temperature conditions, where sealing surface 212 might not contact seal 202, leading to under-squeezing and sealing failure. Conversely, if designed for operative interference 214 at low temperature conditions, seal 202 may expand excessively at high temperature conditions, causing over-squeezing and compression of seal body 204 into extrusion gaps 216. However, to address these problems, sealing system 200 may use non-extrusion devices 100 with seal body 204 to maintain an operative sealing interference 214 for sealing system 200 across cold and hot temperature conditions. As further discussed below, the SMA ring 104 can change the lattice molecular structure at varying temperature conditions, which causes the non-extrusion devices 100 to be in a non-contracted state or a contracted state for providing sufficient sealing in pressurized applications across the temperature extremes.

In some embodiments, seal body 204 may be a polymer, elastomeric, ceramic, metal, composite (e.g., rubber composite), or any other sealing material now known or later developed for use in pressurized applications such as hydraulic systems, fuel systems, engine components, braking systems, or oil and gas sealing systems. In some embodiments, seal 202 is any type of seal made of a polymer material. The term “polymer” shall be understood to mean materials such as natural or synthetic rubber, amorphous polymers whose molecules form an entangled network (characterized by randomness and lack of long-range structure), silicone, fluorosilicone, hydrogenated nitrile (HNBR), fluorocarbon (FKM), perfluoroelastomer (FFKM), AFL (tetrafluoroethylene propylene), ethylene propylene (EPDM), filled or unfilled PTFE (polytetrafluoroethylene), or a seal material that is qualified under API 6A PR2 (Annex F) requirements. Seal 202 may be of any desired shape or form and the amount or portion of seal 202 that contacts sealing surface 212 of second component 208 may vary depending upon the particular application.

In some embodiments, seal 202 is positioned (e.g., disposed) within seal recess 210. Seal recess 210 may be of any desired size, shape, or configuration. In the example depicted in FIG. 2A, seal recess 210 takes the form of a groove that is cut into first component 206 and extends around the entire circumference of first component 206. For example, seal recess 210 may be an annular groove within the first component 206 that fully extends around a central axis 211 of sealing system 200. For instance, during installation, seal 202 may be positioned within seal recess 210 of first component 206 such that seal body 204 and non-extrusion devices 100 of seal 202 extend circumferentially around central axis 211. In some embodiments, seal 202 may be positioned within seal recess 210 so a tolerance is present in sealing system 200. For example, the diameter of seal recess 210 may vary by +1% or −0.5% from the diameter of seal 202, causing seal 202 to have a tighter or looser fit within seal recess 210. For instance, a gap between an edge of seal recess 210 and an edge of seal 202 may be present during and after installation. In some embodiments, no gap may be present.

In some embodiments, first component 206 may represent a housing (e.g., casing) and second component 208 may represent a rotating shaft, where seal 202 is designed to provide a seal against an internal operating pressure within sealing system 200. In some embodiments, sealing system 200 may be a static sealing system, where first component 206 may be a flange, pipe, or vessel wall, while second component 208 may be a cover, cap, or another flange. For example, sealing system 200 may include a gasket between two pipe flanges to seal against fluid leakage. In some embodiments, sealing system 200 may be a dynamic sealing system, where first component 206 may be a pump housing, engine block, or similar component, while second component 208 may be a piston or rod that moves within first component 206. For example, sealing system 200 may include a piston ring sealing against the cylinder wall in an engine. In some embodiments, sealing system 200 may be a rotational sealing system, a hydraulic or pneumatic system, or a valve sealing system.

In some embodiments, sealing system 200 is designed to operate over a temperature range of −59° C. to 343° C. (−75 ° F. to 650° F.). This temperature operating range is provided by example only, and the high and low temperatures of such a design temperature range may change depending on the general application (i.e., operating environment). In general, the term “high temperature condition” will be used to refer to the temperature at or above the first transition temperature, while the term “low temperature condition” will be used to refer to at or below the second transition temperature.

Any number of non-extrusion devices 100 may be embedded within seal body 204 in any manner and any location in accordance with embodiments described herein. For example, a single non-extrusion device 100 may be embedded within seal body 204. In another example, two non-extrusion devices 100 may be embedded within seal body 204. In some embodiments, non-extrusion device 100 is not embedded within seal body 204 and is located on an outer surface of seal 202. In some embodiments, non-extrusion device 100 is embedded within seal body 204 so that non-extrusion device 100 is fully enclosed by seal body 204. In other embodiments, non-extrusion device 100 may only be partially embedded within seal body 204 such that non-extrusion device 100 has at least a portion of a perimeter of non-extrusion device 100 not in contact with seal body 204.

In some embodiments, non-extrusion device 100 is embedded within seal body 204 in a location proximal to an edge of seal recess 210. For example, embedded non-extrusion device 100 may be proximal to a first edge 218a, second edge 218b, or third edge 218c of seal recess 210. In some embodiments, non-extrusion device 100 may be embedded so that non-extrusion device 100 is proximal to at least one of the extrusion gaps 216.

In some embodiments, non-extrusion device 100 may be embedded within seal body 204 so that non-extrusion device 100 is offset a particular distance from at least one of the extrusion gaps 216 and/or at least one of first edge 218a, second edge 218b, or third edge 218c. For example, non-extrusion device 100 may be located at a particular longitudinal distance 220x from first edge 218a and/or third edge 218c. For instance, the midpoint 221 of non-extrusion device 100 may be located at a longitudinal distance of 0.2 centimeters from the first edge 218a. In some embodiments, non-extrusion device 100 may be located at a particular lateral distance 220y from second edge 218b and/or a top edge 222 of first component 206. For example, midpoint 221 of non-extrusion device 100 may be located a lateral distance 220y of 0.2 centimeters from top edge 222. In some embodiments, longitudinal distance 220x or lateral distance 220y may change depending on whether SMA ring 104 is in the contracted state or the non-contracted state. For example, when transitioning from the non-contracted state to the contracted state, the lateral distance 220y of midpoint 221 of non-extrusion device 100 may decrease from 0.3 centimeters to 0.2 centimeter due to the circumferential contraction of SMA ring 104 toward sealing surface 212 at high temperature conditions.

In some embodiments, non-extrusion devices 100 are located proximal to a first extrusion gap edge 224a and/or a second extrusion gap edge 224b of seal body 204 so that seal body 204 is less likely to extrude into extrusion gaps 216 when non-extrusion device 100 transitions from the non-contracted state to the contracted state at high temperature conditions. For example, sealing system 200 may comprise two non-extrusion devices 100, where a first non-extrusion device 100 is located proximal to a first extrusion gap edge 224a and a second non-extrusion device 100 is located proximal to a second extrusion gap edge 224b (e.g., bi-directional sealing).

In some embodiments, a proximal location to first extrusion gap edge 224a and/or second extrusion gap edge 224b may include at least a portion of an outer surface of non-extrusion device 100 not in contact with seal body 204. For example, at least a portion of the outer surface of non-extrusion device 100 may be in direct contact with first edge 218a, third edge 218c, and/or sealing surface 212. In some embodiments, a proximal location to first extrusion gap edge 224a and/or second extrusion gap edge 224b may include no portion of the outer surface of non-extrusion device 100 having direct contact with seal body 204. For example, at least a portion of seal body 204 may be between non-extrusion device 100 and first edge 218a, third edge 218c, and/or sealing surface 212.

First extrusion gap edge 224a or second extrusion gap edge 224b may be a portion of seal body 204 closest to an extrusion gap 216. For example, first extrusion gap edge 224a may be an edge or surface portion of seal body 204 that interfaces with an extrusion gap 216. For instance, first extrusion gap edge 224a may be an outermost portion of seal body 204 exposed to an extrusion gap 216. First extrusion gap edge 224a and second extrusion gap edge 224b may extend around the entire circumference of first component 206 or second component 208. In some embodiments, midpoint 221 of non-extrusion device 100 may be positioned closer to first extrusion gap edge 224a or second extrusion gap edge 224b than second edge 218b. For example, midpoint 221 of non-extrusion device 100 may be a shorter lateral distance 220y from first extrusion gap edge 224a than from second edge 218b.

FIG. 2B illustrates a cross-sectional view of a sealing system using a seal embedded with one or more non-extrusion devices 100, operating at a high temperature, to establish a seal between two components. In some embodiments, as discussed above with respect to FIG. 1B, when SMA ring 104 is heated to a first transition temperature, non-extrusion device 100 transitions from a non-contracted state to a contracted state, where inner diameter 106 of SMA ring 104 circumferentially contracts. For example, SMA ring 104 may circumferentially contract so that inner diameter 106 of SMA ring 104 decreases in size equal to C/(2π).

In response to the contraction of SMA ring 104, non-extrusion device 100 experiences inward contraction 108 such that non-extrusion device 100 contracts in a direction toward sealing surface 212. In some embodiments, inward contraction 108 contracts non-extrusion device 100 toward sealing surface 212 in a direction perpendicular, or substantially perpendicular, to sealing surface 212. By contracting non-extrusion device 100 of seal 202 in the direction toward sealing surface 212, non-extrusion device 100 may at least partially block (or fill) extrusion gaps 216 such that seal body 204 may be prevented from extruding into extrusion gaps 216, avoiding damage to seal 202. For example, during high temperature and high-pressure conditions, where thermal expansion causes seal body 204 and extrusion gaps 216 to expand, non-extrusion device 100 may partially or fully block extrusion gaps 216 to prevent at least a portion of seal body 204 from expanding into extrusion gaps 216. In some embodiments, non-extrusion device 100 blocks a portion of extrusion gaps 216 by directly contacting sealing surface 212, while also directly contacting first edge 218a or third edge 218c.

FIG. 2C illustrates a cross-sectional view of a sealing system using a seal embedded with one or more non-extrusion devices 100, operating at a high temperature, to establish a seal between two components. In some embodiments, extrusion gaps 216 disclosed above in FIGS. 2A-2B may include a process side extrusion gap 216a and an external side extrusion gap 216b. In some embodiments, sealing system 200 may be used for sealing between a first component 206 and a second component 208 in the presence of a pressure 226 coming from process side extrusion gap 216a. For example, under operating conditions, pressure 226 may come from a gas or a liquid and enter process side extrusion gap 216a, resulting in pressure 226 being exerted on seal body 204. For instance, hydraulic fluid under pressure in high temperature conditions may push against seal body 204, where pressure 226 is exerted on seal body 204 from process side extrusion gap 216 a. In some embodiments, pressure 226 may be anywhere from 1 psi to 5,000 psi, from 5,000 psi to 10,000 psi, from 10,000 psi to 15,000 psi, or from 15,000 psi to 30,000 psi. In other embodiments, pressure 226 may be at least 1,000 psi, at least 5,000 psi, or at least 10,000 psi. Pressure 226 exerted on seal body 204 may push seal body 204 towards external side extrusion gap 216b, which may be opposite the process side extrusion gap 217. To prevent extrusion of seal body 204 into external side extrusion gap 216b and deformation of seal 202 from occurring, as discussed above, SMA ring 104 may transition to a contracted state in high temperature conditions associated with high pressure (e.g., up to 20,000 psi) such that non-extrusion device 100 contracts in a direction toward sealing surface 212 to block or partially block seal body 204 from extruding into external side extrusion gap 216b. For example, in this instant application, non-extrusion device 100 may contract in a direction toward external extrusion gap 216b (e.g., toward sealing surface 212) such that non-extrusion device 100 at least partially blocks (or fills) external side extrusion gap 216b. As depicted in FIG. 2C, non-extrusion devices 100 may be contracted and moved closer to sealing surface 212, process side extrusion gap 216a, and/or external side extrusion gap 216b. For instance, non-extrusion device 100 may block (e.g., barricade) seal body 204 from expanding into external side extrusion gap 216b as pressure 226 pushes seal body 204 towards external side extrusion gap 216b.

FIG. 2D illustrates a cross-sectional view of a sealing system using a seal embedded with one or more non-extrusion devices 100, operating at a low temperature. As discussed above in FIG. 1C, when SMA ring 104 is cooled to the second transition temperature, non-extrusion device 100 transitions to the non-contracted state, where SMA ring 104 may return to its pliant shape that SMA ring 104 had in the non-contracted state before being heated to the first transition temperature. In this non-contracted state, non-extrusion device 100 may no longer (e.g., ceases to) experience inward contraction 108 in a direction toward sealing surface 212. Rather, non-extrusion device 100 expands (e.g., circumferentially expands) in outward direction 109 due to the SMA ring 104 returning to the expanded, non-contracted state. Further, while SMA ring 104 is in the non-contracted state, sufficient contact stress may be maintained between seal body 204 and seal recess 210 due to the SMA ring 104 being in the non-contracted state. This expansion of SMA ring 104 may prevent shrinkage or further damage to seal body 204. For example, SMA ring 104 may control and prevent the shrinkage of seal body 204 that occurs naturally as seal body 204 is cooled. As seal body 204 is cooled, seal body 204 may tend to shrink to the center of mass of seal body 204. However, the two-way shape memory effect of SMA ring 104 causes SMA ring 104 to expand back to the non-contracted shape upon being cooled to the second transition temperature and prevent seal body 204 from shrinking while maintaining sufficient contact stress between seal body 204 and seal recess 210. Thus, upon being cooled to the second transition temperature, non-extrusion device 100 may no longer be contracted in a direction toward sealing surface 212, and inner diameter 106 of SMA ring 104 may return to the same or a substantially similar length as the SMA ring 104 had before transitioning to the contracted state, while maintaining an operative sealing interference 214.

Thus, at low temperature and high temperature conditions, sealing system 200 maintains a sealing interference 214 by utilizing the ability of SMA ring 104 to contract at high temperature conditions and return to the pliant shape of SMA ring 104 at low temperature conditions. Further, whenever SMA ring 104 is in the non-contracted state, such as during installation and low temperature conditions, the non-extrusion device 100 is still durable enough to prevent extrusion or mechanical nibbling of seal body 204 from occurring. The pliancy of non-extrusion device 100 in the non-contracted state (e.g., at room temperature) allows for easier installation and removal of seal 202 into seal recess 210.

The terms “pliant” or “pliancy” used herein refer to the ability of non-extrusion device 100 to bend, flex, or deform without breaking when non-extrusion device 100 is in the non-contracted state or the contracted state. The pliancy of non-extrusion device 100 may be influenced by material properties of SMA ring 104 such as elastic modulus, flexural modulus, and hardness, which may determine how easily non-extrusion device 100 may conform to surrounding structures during installation, operation, and/or removal. In some embodiments, an increased pliancy means that non-extrusion device 100 is more flexible and requires less force to bend, flex, or deform. For example, SMA ring 104, including a nitinol alloy, in a martensitic phase may have a relatively low elastic modulus of 20-40 MPa, allowing non-extrusion device 100 to be more easily manipulated during operative conditions without significant resistance, as compared to SMA ring 104 with a higher elastic modulus.

Conversely, in some embodiments, a decreased pliancy means that non-extrusion device 100 may be more rigid and requires greater force to bend, flex, or deform. In a decreased pliancy state, non-extrusion device 100 may provide greater structural integrity and resistance to deformation under a load (e.g., pressure). For example, SMA ring 104, including a nitinol alloy, in an austenitic phase may exhibit a higher elastic modulus of 40-70 GPa, making non-extrusion device 100 less pliant and more resistant to bend, flex, or deform during operative conditions. The degree of pliancy of non-extrusion device 100 may be tailored based on the specific application, ensuring optimal performance in both the non-contracted and contracted states.

FIG. 3 illustrates a chart describing the operational characteristics of an example embodiment of the non-extrusion device 100. The horizontal axis in FIG. 3 is the temperature of SMA ring 104, while the vertical axis reflects the nominal stress on the SMA ring 104. In some embodiments, SMA ring 104 comprises a two-way SMA material where SMA ring 104 transitions between a non-contracted state and a contracted state, depending upon the temperature to which SMA ring 104 is exposed. As discussed above in FIGS. 1A-1C, SMA ring 104 may be made of a variety of materials. In some embodiments, SMA ring 104 comprises nickel and titanium. For example, SMA ring 104 may comprise 49.9% nickel and 50.1% titanium (Ni_{49.9}Ti_{50.1}). When SMA ring 104 is comprised of a material such as Ni_{49.9}Ti_{50.1}, SMA ring 104 may be “trained” by applying a constant stress and by cycling the temperature for many cycles (e.g., 100 cycles) of complete phase transformation between SMA ring 104 being in a non-contracted state and a contracted state.

In general, SMA ring 104 disclosed herein transforms from austenite (the structure of SMA ring 104 in a contracted state) to martensite (the structure of SMA ring 104 in a non-contracted state) upon cooling. With reference to FIG. 2C, in some embodiments, where SMA ring 104 is comprised of Ni_{49.9}Ti_{50.1}, SMA ring 104 may be designed such that SMA ring 104 is in the non-contracted state (e.g., martensite) at or near the installation temperature that is anticipated at the time when SMA ring 104 is installed in the seal recess 210 along with seal 202. In some embodiments, for most applications, the installation temperature will fall within the normal room temperature range in different regions of the world, i.e., a range of about 15° C. to 38° C. (60° F. to 100° F.) (inclusive of endpoints), and the installation temperature will be above the martensite start transformation temperature (Ms) 302 (e.g., second transition temperature)-the temperature where SMA ring 104 starts its transformation from austenite to martensite. In some embodiments, the material of SMA ring 104 may be designed such that martensite start transformation temperature 302 is less than the lowest anticipated installation temperature. In some embodiments, wherein the shape memory material for SMA ring 104 is Ni_{49.9}Ti_{50.1}, the martensite start transformation temperature 302 may be about 12.8° C. (55° F.); the martensite finish transformation temperature (Mf) 304 may be about −1° C. (30° F.); the austenite start transformation temperature (As) 306 (e.g., first transition temperature) may be about 27.8° C. (82 ° F.); and the austenite finish transformation temperature (Af) 308 may be about 42.8° C. (109° F.). Thus, with reference to FIG. 3, during cooling, the SMA ring 104 may start changing from austenite to martensite at point B and complete the transformation to martensite at point C (wherein SMA ring 104 is in the non-contracted state). Similarly, during heating, SMA ring 104 may start transforming from martensite to austenite at point E and complete the transformation to austenite at point F (wherein SMA ring 104 is in the contracted state).

With continuing reference to FIG. 3, from point A to B, SMA ring 104 is in the contracted state and substantially all austenite. During installation, SMA ring 104 may be in the non-contracted state and embedded within seal body 204. Once sealing system 200 is placed in operation, as long as SMA ring 104 is at a temperature that is below the martensite start transformation temperature 302, SMA ring 104 will remain in its non-contracted state, and seal 202 may be designed to have a proper amount of interference 214 with sealing surface 212 over this range of temperature, i.e., the range from martensite start transformation temperature 302 to the minimum design temperature (Point D) for seal 202. However, once the temperature of SMA ring 104 is increased to a point where the temperature equals the austenite start transformation temperature 306 at point E, SMA ring 104 may begin transforming from martensite to austenite. The transformation continues from point E to F, where at point F, SMA ring 104 is substantially all austenite and in its contracted state. That is, once the temperature of SMA ring 104 is heated to its final transformation temperature (from point E to point F), SMA ring 104 may circumferentially contract so that a diameter of SMA ring 104 decreases in size equal to C/(2π). The circumferential contraction ensures that an operative seal interference 214 is maintained even at the upper end of the overall design temperature range (Point A) for seal 202 without extrusion occurring (as discussed above in FIGS. 2A-2D).

As discussed above in FIG. 2D, Upon cooling of sealing system 200, SMA ring 104 may return to the non-contracted state, where inward contraction 108 no longer contracts non-extrusion device 100 in a direction toward sealing surface 212. Once the temperature of SMA ring 104 is decreased to a point where it equals the martensite start transformation temperature 302 at point B, SMA ring 104 begins transforming from austenite to martensite. The transformation continues from point B to C, wherein at point C, SMA ring 104 is substantially all martensite and is in a non-contracted state. Thus, as sealing system 200 returns to low temperature conditions, SMA ring 104 transforms to the non-contracted state where inner diameter 106 of SMA ring 104 no longer has an increased tendency to decrease in length due to inward contraction 108, and seal 202 may be designed so that there is still a proper amount of interference 214 with sealing surface 212 at temperatures below the martensite finish transformation temperature 304. For example, seal 202 may be cooled to low temperatures without fear of providing too large or too small of an interference 214 between seal 202 and sealing surface 212 that results in undesirable permanent deformation of seal 202.

FIG. 4 illustrates an exemplary method 400 of manufacturing a sealing system using one or more non-extrusion devices. At step 402, a seal may be formed. The seal may be formed by embedding an SMA ring within a non-extrusion ring to form a non-extrusion device. The non-extrusion device may then be embedded within a seal body of the seal. The formed seal may have all the aspects and features of components disclosed above in FIGS. 1-3, such as non-extrusion device 100, non-extrusion ring 102, SMA ring 104, seal 202, and seal body 204.

At step 404, the seal may be disposed onto a first component, so the seal is positioned in a seal recess defined in the first component. The first component and the seal recess may have all aspects and features of components disclosed above in FIGS. 1-3, such as first component 206 and seal recess 118. In some embodiments, the seal is in a non-contracted state and is installed at low temperature conditions (e.g., room temperature) so the seal can be stretched and formed over the seal recess (e.g., groove). In some embodiments, a butterfly method may be used to install the seal, where the seal is folded or compressed to fit into the seal recess (e.g., internal diameter (ID) groove) of the first component.

At step 406, a second component may be installed such that a sealing surface of the second component contacts a surface of the seal, where one or more extrusion gaps are formed between the sealing surface and the surface of the seal. The second component, the sealing surface, and the one or more extrusion gaps may have all aspects and features of components disclosed above in FIGS. 1-3, such as second component 208, sealing surface 212, and extrusion gaps 216.

At step 408, the non-extrusion device may be embedded within the seal body so the non-extrusion device is proximal to an extrusion gap edge after the second component is installed. For example, as discussed above in FIG. 2A, the non-extrusion device may be embedded within the seal body, so the non-extrusion device is offset a particular distance from at least one of the extrusion gaps and/or at least one of a first edge, second edge, or third edge of the seal recess. In some embodiments, the non-extrusion device may be embedded within the seal body, so the non-extrusion device is located proximal to an extrusion gap edge. This proximity to an extrusion gap edge makes it less likely that the seal body will extrude into the extrusion gaps when the non-extrusion device transitions from the non-contracted state to the contracted state at high temperature conditions and contracts toward the sealing surface. In some embodiments, the seal may comprise two non-extrusion devices, where each non-extrusion device is located proximal to an extrusion gap edge.

The following embodiments represent exemplary embodiments of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting.

Clause 1. A seal, comprising: a seal body; and a non-extrusion device embedded within the seal body at a location proximal to an extrusion gap edge of the seal body, the non-extrusion device comprising: a non-extrusion ring; and a shape memory alloy (SMA) ring embedded within the non-extrusion ring; wherein the non-extrusion device is in a non-contracted state at a first temperature and a contracted state at a second temperature, wherein the second temperature is higher than the first temperature; and wherein the non-extrusion device transitions from the non-contracted state to the contracted state upon reaching a first transition temperature.

Clause 2. The seal of clause 1, wherein the SMA ring is a helical spring comprising one or more strands of SMA wire.

Clause 3. The seal of any of clauses 1 or 2, wherein the SMA ring begins changing from a martensitic molecular structure to an austenitic molecular structure upon the SMA ring reaching the first transition temperature, wherein the first transition temperature is an austenite start transformation temperature.

Clause 4. The seal of any of clauses 1 through 3, wherein after the SMA ring reaches the first transition temperature, the SMA ring finishes changing to the austenitic molecular structure upon the SMA ring reaching a first finish transition temperature, wherein the first finish transition temperature is an austenite finish transformation temperature, wherein the SMA ring begins changing from the austenitic molecular structure to the martensitic molecular structure upon the SMA ring reaching a second transition temperature, wherein the second transition temperature is a martensite start transformation temperature.

Clause 5. The seal of any of clauses 1 through 4, wherein the SMA ring finishes changing to the martensitic molecular structure upon the SMA ring reaching a second finish transition temperature, wherein the second finish transition temperature is a martensite finish temperature.

Clause 6. The seal of any of clauses 1 through 5, wherein the first transition temperature is higher than the second transition temperature.

Clause 7. The seal of any of clauses 1 through 6, wherein the SMA ring begins to circumferentially contract upon the SMA ring reaching the first transition temperature.

Clause 8. The seal of any of clauses 1 through 7, wherein the non-extrusion ring is a flat spring.

Clause 9. A sealing system, comprising: a first component comprising a seal recess defined in the first component; a second component comprising a sealing surface; and a seal positioned in the seal recess, the seal comprising: a seal body; and a non-extrusion device embedded within the seal body, the non-extrusion device comprising: a non-extrusion ring; and a shape memory alloy (SMA) ring embedded within the non-extrusion ring, wherein the non-extrusion device is in a non-contracted state at a first temperature and a contracted state at a second temperature, wherein the non-extrusion device transitions from the non-contracted state to the contracted state upon reaching a first transition temperature, and wherein, upon reaching the first transition temperature, the SMA ring circumferentially contracts such that the non-extrusion device contracts in a direction toward the sealing surface.

Clause 10. The sealing system of clause 9, further comprising: one or more extrusion gaps located between the first component and the second component, wherein the non-extrusion device contracts in the direction toward the sealing surface such that the non-extrusion device at least partially blocks the one or more extrusion gaps.

Clause 11. The sealing system of any of clauses 9 or 10, wherein the seal further comprises: an extrusion gap edge, wherein the non-extrusion device is embedded within the seal body at a location proximal to the extrusion gap edge.

Clause 12. The sealing system of any of clauses 9 through 11, wherein the non-extrusion device transitions from the contracted state to the non-contracted state upon reaching a second transition temperature such that the non-extrusion device ceases to contract in the direction toward the sealing surface.

Clause 13. The sealing system of any of clauses 9 through 12, wherein the second transition temperature is lower than the first transition temperature.

Clause 14. The sealing system of any of clauses 9 through 13, wherein the second transition temperature is a martensite start temperature of the SMA ring.

Clause 15. The sealing system of any of clauses 9 through 14, wherein the seal has a first pliancy in the non-contracted state and a second pliancy in the contracted state, wherein the first pliancy is greater than the second pliancy.

Clause 16. The sealing system of any of clauses 9 through 15, wherein the first transition temperature is an austenite start temperature of the SMA ring.

Clause 17. The sealing system of any of clauses 9 through 16, wherein the first transition temperature is determined by a ratio of nickel to titanium that the SMA ring comprises.

Clause 18. A method of manufacturing a sealing system, the method comprising: forming a seal, wherein the seal is formed by: embedding a shape memory alloy (SMA) ring within a non-extrusion ring to form a non-extrusion device; and embedding the non-extrusion device within a seal body; disposing the seal onto a first component such that the seal is positioned in a seal recess defined in the first component; and installing a second component, such that a sealing surface of the second component contacts a surface of the seal, wherein one or more extrusion gaps are formed between the sealing surface and the surface of the seal, wherein the non-extrusion device is embedded within the seal body such that the non-extrusion device is proximal to an extrusion gap edge of the seal body after the second component is installed.

Clause 19. The method of clause 18, wherein the method further comprises: heating the seal to a first transition temperature, wherein upon reaching the first transition temperature, the SMA ring begins to circumferentially contract from a non-contracted state to a contracted state such that the non-extrusion device contracts in a direction toward the sealing surface, wherein the non-extrusion device at least partially blocks the one or more extrusion gaps.

Clause 20. The method of any of clauses 18 or 19, wherein the method further comprises: cooling the seal to a second transition temperature, wherein upon reaching the second transition temperature, the SMA ring begins to circumferentially expand from the contracted state to the non-contracted state, such that the non-extrusion device ceases to contract in the direction toward the sealing surface.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A seal, comprising:
a seal body; and
a non-extrusion device embedded within the seal body at a location proximal to an extrusion gap edge of the seal body, the non-extrusion device comprising:
a non-extrusion ring comprising a polymer material; and
a shape memory alloy (SMA) ring embedded within the non-extrusion ring, wherein the non-extrusion device is fully enclosed by the seal body;
wherein the non-extrusion device is in a non-contracted state at a first temperature and a contracted state at a second temperature, wherein the second temperature is higher than the first temperature; and
wherein the non-extrusion device transitions from the non-contracted state to the contracted state upon reaching a first transition temperature.

2. The seal of claim 1, wherein the SMA ring is a helical spring comprising one or more strands of SMA wire.

3. The seal of claim 1, wherein the SMA ring begins changing from a martensitic molecular structure to an austenitic molecular structure upon the SMA ring reaching the first transition temperature, wherein the first transition temperature is an austenite start transformation temperature.

4. The seal of claim 3, wherein after the SMA ring reaches the first transition temperature, the SMA ring finishes changing to the austenitic molecular structure upon the SMA ring reaching a first finish transition temperature, wherein the first finish transition temperature is an austenite finish transformation temperature, wherein the SMA ring begins changing from the austenitic molecular structure to the martensitic molecular structure upon the SMA ring reaching a second transition temperature, wherein the second transition temperature is a martensite start transformation temperature.

5. The seal of claim 4, wherein the SMA ring finishes changing to the martensitic molecular structure upon the SMA ring reaching a second finish transition temperature, wherein the second finish transition temperature is a martensite finish temperature.

6. The seal of claim 4, wherein the first transition temperature is higher than the second transition temperature.

7. The seal of claim 1, wherein the SMA ring begins to circumferentially contract upon the SMA ring reaching the first transition temperature.

8. The seal of claim 1, wherein the non-extrusion ring is a flat spring.

9. A sealing system, comprising:
a first component comprising a seal recess defined in the first component;
a second component comprising a sealing surface; and
a seal positioned in the seal recess, the seal comprising:
a seal body; and
a non-extrusion device embedded within the seal body, the non-extrusion device comprising:
a non-extrusion ring comprising a polymer material; and
a shape memory alloy (SMA) ring embedded within the non-extrusion ring, wherein the non-extrusion device is fully enclosed by the seal body,
wherein the non-extrusion device is in a non-contracted state at a first temperature and a contracted state at a second temperature,
wherein the non-extrusion device transitions from the non-contracted state to the contracted state upon reaching a first transition temperature, and
wherein, upon reaching the first transition temperature, the SMA ring circumferentially contracts such that the non-extrusion device contracts in a direction toward the sealing surface.

10. The sealing system of claim 9, further comprising:
one or more extrusion gaps located between the first component and the second component, wherein the non-extrusion device contracts in the direction toward the sealing surface such that the non-extrusion device at least partially blocks the one or more extrusion gaps.

11. The sealing system of claim 10, wherein the seal further comprises:
an extrusion gap edge, wherein the non-extrusion device is embedded within the seal body at a location proximal to the extrusion gap edge.

12. The sealing system of claim 9, wherein the non-extrusion device transitions from the contracted state to the non-contracted state upon reaching a second transition temperature such that the non-extrusion device ceases to contract in the direction toward the sealing surface.

13. The sealing system of claim 12, wherein the second transition temperature is lower than the first transition temperature.

14. The sealing system of claim 12, wherein the second transition temperature is a martensite start temperature of the SMA ring.

15. The sealing system of claim 9, wherein the seal has a first pliancy in the non-contracted state and a second pliancy in the contracted state, wherein the first pliancy is greater than the second pliancy.

16. The sealing system of claim 9, wherein the first transition temperature is an austenite start temperature of the SMA ring.

17. The sealing system of claim 9, wherein the first transition temperature is determined by a ratio of nickel to titanium that the SMA ring comprises.

18. A method of manufacturing a sealing system, the method comprising:
forming a seal, wherein the seal is formed by:
embedding a shape memory alloy (SMA) ring within a non-extrusion ring to form a non-extrusion device, wherein the non-extrusion ring comprises a polymer material; and
embedding the non-extrusion device within a seal body, wherein the non-extrusion device is fully enclosed by the seal body;
disposing the seal onto a first component such that the seal is positioned in a seal recess defined in the first component; and
installing a second component, such that a sealing surface of the second component contacts a surface of the seal, wherein one or more extrusion gaps are formed between the sealing surface and the surface of the seal,
wherein the non-extrusion device is embedded within the seal body such that the non-extrusion device is proximal to an extrusion gap edge of the seal body after the second component is installed.

19. The method of claim 18, wherein the method further comprises:
heating the seal to a first transition temperature, wherein upon reaching the first transition temperature, the SMA ring begins to circumferentially contract from a non-contracted state to a contracted state such that the non-extrusion device contracts in a direction toward the sealing surface, wherein the non-extrusion device at least partially blocks the one or more extrusion gaps.

20. The method of claim 19, wherein the method further comprises:
cooling the seal to a second transition temperature, wherein upon reaching the second transition temperature, the SMA ring begins to circumferentially expand from the contracted state to the non-contracted state, such that the non-extrusion device ceases to contract in the direction toward the sealing surface.
